(19) United States
(12) Patent Application Publication
(10) Pub. No.: US 2026/0100581 A1
(43) Pub. Date: Apr. 9, 2026

(54) PRIORITY DISPATCH REGIONS FOR COORDINATION OF CONTROL OBJECTIVES IN ELECTRICAL POWER SYSTEMS

(71) Applicant: Schweitzer Engineering Laboratories, Inc., Pullman, WA (US)

(72) Inventor: William F. Allen, Airdrie (CA)

(73) Assignee: Schweitzer Engineering Laboratories, Inc., Pullman, WA (US)

(21) Appl. No.: 18/908,043

(22) Filed: Oct. 7, 2024

(51) Int. Cl. H02J 3/00

(52) U.S. Cl. CPC H02J 3/0075; H02J 2103/35

(57) ABSTRACT

Systems and methods for controlling dispatchable elements of a microgrid, such as generators or a point of common coupling, to achieve control objectives of the microgrid are provided. A monitoring and control system may determine a set of prioritized control objectives corresponding to a number of dispatchable elements of a microgrid and a combined dispatch region for the microgrid based on the prioritized control objectives. The monitoring and control system may control the plurality of dispatchable elements based on the combined dispatch region.

### BACKGROUND

This disclosure relates to controlling dispatchable elements of a microgrid of an electric power delivery system.

Electric power delivery systems are used to transmit electric power from generators to loads. Some parts of an electric power delivery system, often referred to interchangeably as microgrids or islands, may be able to be isolated from the other parts of the electric power delivery system. In many cases, a microgrid may have some number of local loads that consume electricity and local sources that provide electricity, such as a photovoltaic source, battery electric storage, or a generator. A point of common coupling (PCC) may selectively connect or disconnect the microgrid to the another part of the electric power delivery system.

There may be several control objectives in an electric power system associated with frequency, voltage, active power, reactive power, state-of-charge, or other measurable quantities found in an electric power system. The control objectives depend on the grid-connected/islanded state of the power system. Some control objectives may be enabled or disabled by an operator or according to an automated scheme while others are critical objectives that are always enabled. Control objectives may be related to points of common coupling with other electric power systems, interconnections between areas within an electric power system, individual nodes or buses within an electric power system, and individual sources of active or reactive power connected to an electric power system. Modern microgrids can have many control objectives that are applied based on conditions, time of day, temperature, forecasts, work schedules, etc. In some cases, two or more control objectives may be in conflict. This issue is currently addressed by customized logical expressions to enable and disable, or bias, control signals in response to changing conditions. In some cases, alarms are generated to notify an operator that the system is operating in a non-preferred state. The operator then takes action to address the alarm condition. These current solutions involve an excessive amount of engineering and subsequent testing to ensure full coverage of all possible situations that may result in conflicting dispatch objectives. This problem grows quickly as the complexity of the subject electrical system increases, the number of dispatchable elements increases, and the number and type of control objectives increases.

### BRIEF DESCRIPTION OF THE DRAWINGS

FIG. 1 is a block diagram of a microgrid with dispatchable elements that may have different control objectives;

FIG. 2 is a diagram depicting prioritized control objectives in relation to a present measurement for one dispatchable element of a microgrid;

FIG. 3 is a diagram depicting a permissible dispatch range for a first control objective of the dispatchable element referred to in FIG. 2;

FIG. 4 is a diagram depicting a permissible dispatch range for a second control objective of the dispatchable element referred to in FIG. 2;

FIG. 5 is a diagram depicting a permissible dispatch range for a third control objective of the dispatchable element referred to in FIG. 2;

FIG. 6 illustrates tables of permissible dispatch ranges and a resulting plot of a prioritized dispatch region for the dispatchable element referred to in FIG. 2;

FIG. 7 illustrates a combination of prioritized dispatch regions of multiple dispatchable elements of the microgrid to generate a combined priority dispatch region;

FIG. 8 is a diagram illustrating a manner of determining a dispatch solution of the microgrid based on the combined priority dispatch region;

FIG. 9 is a diagram illustrating a manner of implementing the dispatch solution of the microgrid by applying a dispatch shift function to the dispatchable elements of the microgrid individually;

FIG. 10 is a flowchart of a method for determining and implementing a dispatch solution involving prioritized control objectives for a number of dispatchable elements of a microgrid; and

FIG. 11 is a diagram illustrating a manner of obtaining a control quality metric that describes a degree to which the prioritized control objectives are met by a control scheme.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase “A or B” is intended to mean A, B, or both A and B.

As mentioned above, modern microgrids can have many control objectives that are applied based on conditions, time of day, temperature, forecasts, work schedules, and so on. In some cases, two or more control objectives may be in conflict. This disclosure provides systems and methods to determine and implement a dispatch control scheme for a variety of dispatchable elements of a microgrid to account for the numerous control objectives that may be under consideration.

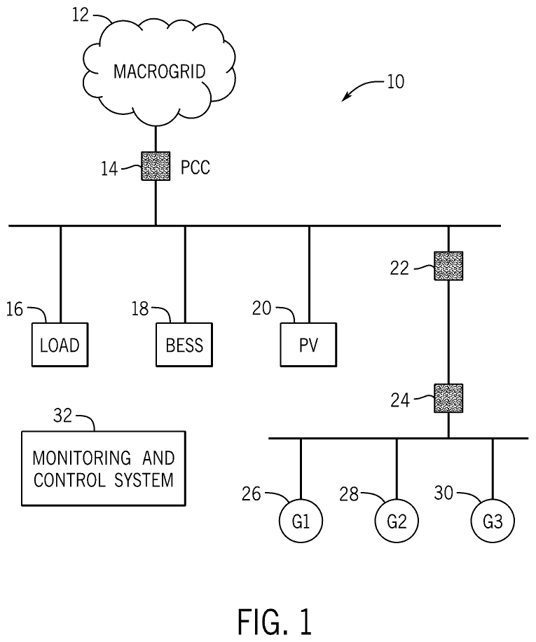

FIG. 1 is a block diagram of a microgrid 10 representing an example of the type of electrical power delivery system that may employ the systems and methods of this disclosure. While the systems and methods of this disclosure are described as applicable to a microgrid, such as the microgrid 10, it should be appreciated that they may be used to control any suitable electric power delivery system of any size containing at least one dispatchable element. Moreover, the microgrid 10 shown in FIG. 1 is provided by way of example and may include more or fewer elements. In the example of FIG. 1, the microgrid 10 may operate on its own in an island mode or may be connected to another electric power delivery system, referred to as a macrogrid 12 (e.g., a local power grid, a regional power grid, a national power grid, another microgrid) through a point of common coupling (PCC) 14. The PCC 14 may represent any suitable relay or breaker that may selectively couple or decouple the microgrid 10 to the macrogrid 12. The PCC 14 may be treated as a dispatchable element of the microgrid 10, since its state may supply power to or draw power from the microgrid 10.

The microgrid 10 may provide electric power to any suitable load 16, such as machines, buildings, electric lighting, motors, or the like. To the extent that the power drawn by the load 16 can be dispatched (e.g., the amount of power drawn may be controlled to increase or decrease), the load 16 or part of the load 16 may be treated as a dispatchable element of the microgrid 10. Other components of the microgrid 10 may include replenishable electric storage systems such as a battery energy storage system (BESS) 18. The microgrid may also include intermittent sources such as a photovoltaic (PV) supply 20. The BESS 18 may sometimes act as a dispatchable element, providing electric power on demand, but other times may act as a load drawing power during charging. The PV supply 20 may be less dispatchable but may provide an intermittent source of energy based on the availability of sunlight. Through some breakers or relays 22 and 24, additional generators G1 26, G2 28, and G3 30 may provide dispatchable power to the rest of the microgrid 10. The generators G1 26, G2 28, and G3 30 may represent any suitable electric power generators that may provide power to microgrid 10.

The various components of the microgrid 10 may have differing control objectives. A monitoring and control system 32 may control the components of the microgrid 10 according to a control scheme that balances the various control objectives as provided in this disclosure. The monitoring and control system 32 may include any suitable circuitry to carry out these techniques. For example, the monitoring and control system 32 may include a data processing system that includes one or more processors that execute instructions stored in memory and/or nonvolatile storage. In other words, the monitoring and control system 32 may include hardware elements (including circuitry), software elements (including computer code stored on a computer-readable medium), or a combination of both hardware and software elements. In some embodiments, the monitoring and control system 32 may be implemented using a field programmable gate array (FPGA) or one or more application specific integrated circuits (ASICs). Moreover, while the monitoring and control system 32 is shown to be local to the microgrid 10, the monitoring and control system 32 may be part of a control system for the macrogrid 12 (e.g., a supervisory control and data acquisition (SCADA) system) that also controls the microgrid 10.

The monitoring and control system 32 may monitor the microgrid 10 using any suitable IEDs and/or other suitable sensors, such as electrical sensors or temperature sensors, and so forth. The monitoring and control system 32 may receive and act on information relating to, among other things, voltages, currents, fault detections, fault locations, and the like. As used herein, an IED may refer to any microprocessor-based device that monitors, controls, automates, and/or protects monitored equipment. Such devices may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, and the like. The term IED may be used to describe an individual IED or a system that includes multiple IEDs.

The monitoring and control system 32 may solve the problem of multiple competing control objectives in a systematic manner for any number of control objectives while satisfying as many of the control objectives as possible according to their relative importance. Each control objective may be assigned by the monitoring and control system 32 to either active power or reactive power with a specific priority. Each control objective corresponds to an incremental power range. Control objectives may include, for example, power limits and setpoints; battery state of charge (SOC) limits, setpoints and targets; capability curves; frequency limits and setpoints; voltage limits and setpoints; synchronization adjustments. The monitoring and control system 32 may process an active power strategy and a reactive power strategy for the microgrid 10 (or in the case of the monitoring and control system 32 being a control system (e.g., SCADA system) for each microgrid in the macrogrid 12 (e.g., the microgrid 10 as well as other microgrids in the macrogrid 12 other than the microgrid 10).

Each control objective may be defined within a dispatch range (e.g., minimum, maximum) of power increments that can be added by a particular dispatchable element or a collection of dispatchable elements without violating the control objective. For example, a control objective may be assigned to a link (e.g., line or breaker) within the microgrid 10 that connects two parts of the microgrid 10 together. In this case, the objective may define a range of power increments to add or remove from each part of the microgrid 10. These increments apply to the collection of dispatchable elements on each side of the link that the objective is referencing. A positive value represents an addition of power to the microgrid 10. A negative value represents a removal of power from the microgrid 10. The following examples illustrate the dispatch range conventions.

Example 1: A dispatch range of (−50 kW, 60 kW) indicates that up to 50 kW of generation could be removed from the microgrid 10 (e.g., by reducing power generated by the generators G1 26, G2, 28, or G3 30) and up to 60 kW of generation could be added to the microgrid 10 (e.g., by increasing power generated by the generators G1 26, G2, 28, or G3 30) without violating the objective. Since 0 is within this range, this control objective is currently satisfied.

Example 2: A dispatch range of (50 kW, 100 kW) indicates that at least 50 kW of generation must be added to the microgrid 10 (e.g., by increasing power generated by the generators G1 26, G2, 28, or G3 30) but no more than 100 kW of generation can be added to the microgrid 10 to satisfy this control objective. Since 0 is not within this range, the control objective is currently not satisfied.

Example 3: A dispatch range of (−80 kW, −20 kW) indicates that at least 20 kW of generation must be removed from the microgrid 10 (e.g., by reducing power generated by the generators G1 26, G2, 28, or G3 30) but no more than 80 kW of generation can be removed from the microgrid 10 to satisfy the control objective. Since 0 is not within this range, the control objective is currently not satisfied.

These independent dispatch ranges may be sorted by priority. Priority 1 is the most critical, priority 2 is the next most critical, and so on. The sorted list of independent dispatch ranges may be adjusted to ensure that the more critical control objectives are not sacrificed for less critical control objectives. There may be any suitable number of control objectives sorted by any suitable levels of priority. Although this disclosure will provide specific examples that involve three levels of priority for ease of explanation, any suitable number (e.g., 2, 4, 5, 7, 10, 20, 50, 100, 1000) of priority levels may be used.

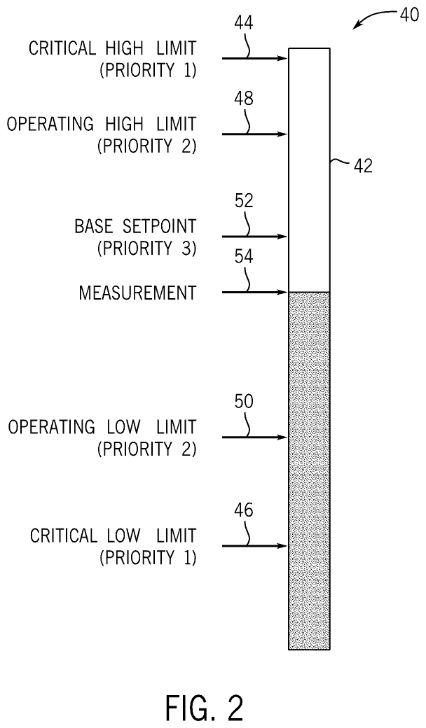

FIG. 2 illustrates an example of a prioritized set of active power control objectives 40 for one dispatchable element of the microgrid 10 in relation to a range of active power 42. In this example, the prioritized set of control objectives 40 corresponds to active power control objectives for the generator G1 26. Similar prioritized sets of active power control objectives may be defined for the other dispatchable elements of the microgrid 10. In FIG. 2, the prioritized set of active power control objectives 40 includes highest priority (Priority 1) control objectives of a critical high-power limit 44 and a critical low power limit 44, medium priority (Priority 2) control objectives of an operating higher power limit 48 and an operating lower power limit 50, and a lowest priority (Priority 3) control objective of a base setpoint 52. A present measurement 54 indicates a present level of active power in relation to the control objectives 40.

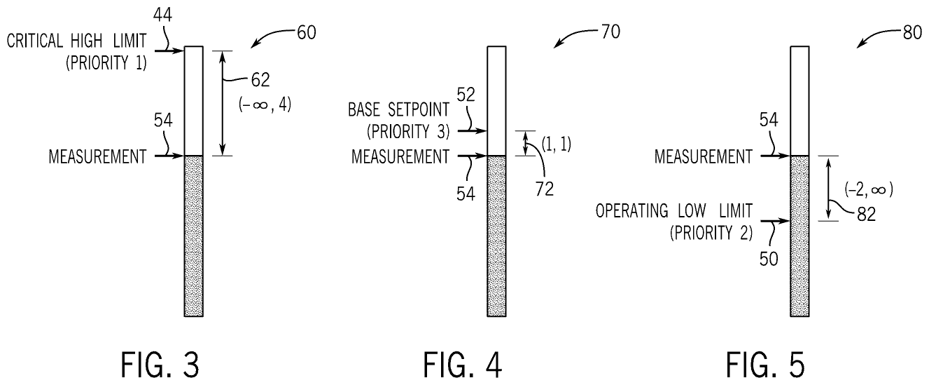

Each control objective may be represented as a range of incremental power that can be added or removed while not violating the control objective. For example, as shown by an incremental dispatch range diagram 60 in FIG. 3, an incremental dispatch range 62 of 4 MW can be added to the generator G1 26 without violating the control objective of the critical high-power limit 44, while any amount can be removed without violating the critical high-power limit 44. Therefore, the incremental dispatch range 62 for the critical high-power limit 44 control objective is (−infinite, 4). Every control objective may be represented in a similar manner. An incremental dispatch range diagram 70 in FIG. 4 illustrates an incremental dispatch range 72 showing that 1 MW must be added but no more than 1 MW to satisfy the base setpoint 52 control objective. Therefore, the incremental dispatch range 72 for the base setpoint 52 control objective is (1, 1). Likewise, an incremental dispatch range diagram 80 in FIG. 4 illustrates an incremental dispatch range 82 showing that, for the operating lower limit 50 control objective, 2 MW can be removed and any amount can be added. Thus, the incremental dispatch range 82 for the operating lower limit 50 control objective is (−2, infinite).

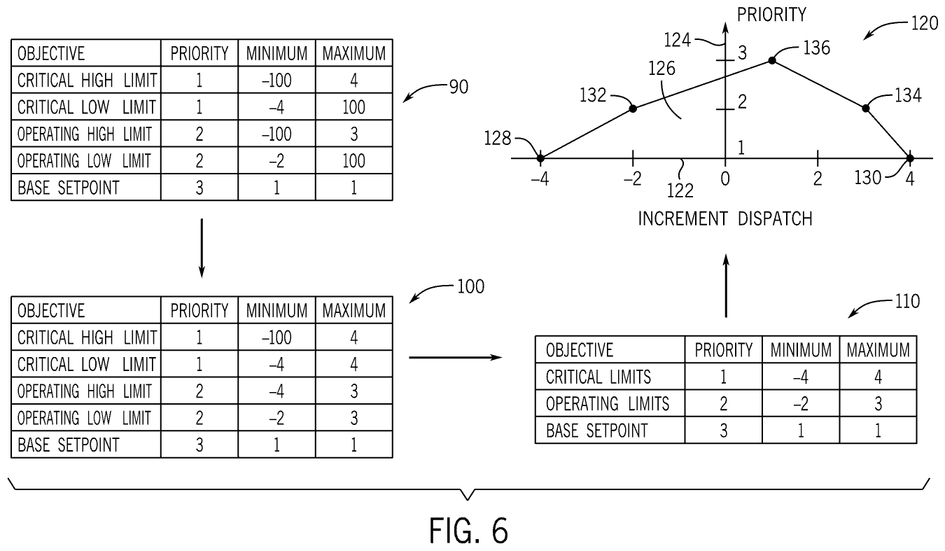

All the control objectives for the generator G1 26 may be organized to form a list of adjusted dispatch ranges bounded by adjusted prioritized control objectives. FIG. 6 provides one example in which all of the incremental dispatch ranges for the various control objectives are provided in a table 90. Going line by line from the highest priority (Priority 1) to the lowest priority (Priority 3) in a table 100, the most restrictive incremental dispatch range is inherited from the previous incremental dispatch range on the previous line. Therefore, as shown in a table 110, a set of adjusted dispatch ranges may be defined for each control objective priority level. This condenses all of the control objectives that may be found at a particular priority level into a single range (e.g., particularly if there are three or more control objectives at the same priority level for a single dispatchable element).

The adjusted dispatch ranges may be visualized as a prioritized dispatch region plot 120. An abscissa 122 of the plot 120 represents active power in MW in relation to a present output at the origin (0) and an ordinate 124 of the plot 120 represents the various priority levels of the control objectives (here, 1, 2, and 3). A dispatch region 126 represents the area beneath a piecewise curve formed by plots of the adjusted dispatch ranges for the various priority levels. A point 128 represents the lower bound and a point 130 represents the upper bound of the adjusted dispatch range for the Priority 1 control objectives. A point 132 represents the lower bound and a point 134 represents the upper bound of the adjusted dispatch range for the Priority 2 control objectives. A point 136 represents both the lower bound and the upper bound of the adjusted dispatch range for the Priority 3 control objectives.

The prioritized dispatch region plot 120 provides a convenient way to immediately visualize the possible ways to control a single dispatchable element, such as the generator G1 26. From the plot 120, it is apparent that the priority 1 and priority 2 control objectives are being met, but the priority 3 control objectives are not being met.

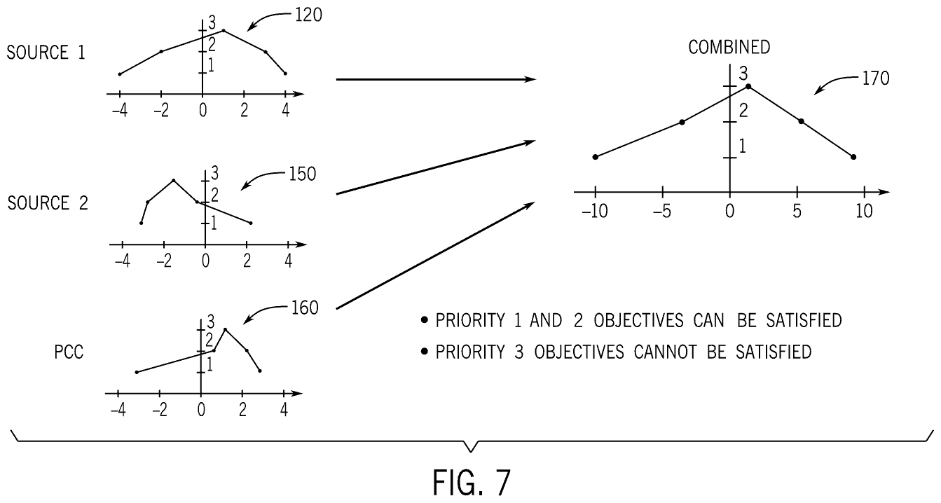

While the prioritized dispatch region plot 120 illustrates a prioritized dispatch region for a single dispatchable element of the microgrid 10, a single dispatchable element of the microgrid 10 may not be controlled without taking into a consideration the control objectives for the other dispatchable elements of the microgrid 10. Thus, as shown by FIG. 7, adjusted dispatch ranges may be determined for the other dispatchable elements of the microgrid 10, which may be visualized as a prioritized dispatch regions plot 150 for the second generator G2 28 and a prioritized dispatch regions plot 160 for the PCC 14. These may be combined by adding the points at each priority level together to form a combined prioritized dispatch region plot 170. The combined prioritized dispatch region plot 170 represents combined dispatch region for all of the subject dispatchable elements of the microgrid 10 that may be dispatched by the monitoring and control system 32. Each priority in the combined priority dispatch region plot 170 has a range (minimum, maximum) of power that can be added to the microgrid 10 to address all control objectives of that priority as well as all control objectives that are more critical (e.g., smaller priority numbers). The combined priority dispatch region plot 170 represents what is possible with respect to satisfying all control objectives of each priority. In this example, the combined priority dispatch region plot 170 shows that there is a dispatch solution that can satisfy all of priority 1 and 2 control objectives in the power system, but there is no solution that can also satisfy priority 3 control objectives.

As can be seen from the plots 150 and 160 in FIG. 7, the current operating state is not satisfying priority 2 control objectives of the generator G2 28 or the PCC 14. The monitoring and control system 32 may send a set of dispatch requests to control the various dispatchable elements of the microgrid 10, which may shift the operation of the generator G2 28 and the PCC 14 so that all priority 2 control objectives are also satisfied.

There are many dispatch solutions that can satisfy the priority 2 objectives of the generator G1 26 (plot 120) the generator G2 28 (plot 150) or the PCC 14 (plot 160). The solution is selected based on a shift function, which shifts the present dispatch to the right or the left. There are many possible shift functions that can be used to identify a dispatch that satisfies all of priority 2 objectives. One example is equal percentage dispatch, where each dispatchable element is adjusted in equal percentage terms, so that all the dispatchable elements share the benefit and the burden of the shift function. If certain dispatchable elements of the microgrid 10 may themselves be prioritized, the different dispatchable elements may be shifted in relative measure according to a weighting function, which may weight different dispatchable elements differently.

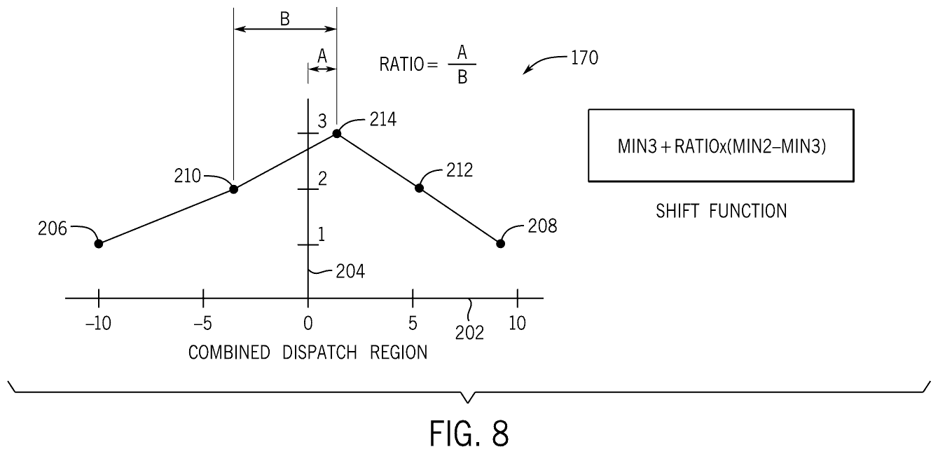

One way to determine an amount by which to shift the dispatchable elements of the microgrid is to obtain a ratio of the priorities that are possible to satisfy in relation to that of the next lower priority that is not possible to satisfy. To visualize this process, FIG. 8 illustrates a way to use the combined priority dispatch region plot 170 to determine such a ratio. In FIG. 8, the combined priority dispatch region plot 170 includes an abscissa 202 that represents active power in MW in relation to a present output at the origin (0) and an ordinate 204 of the plot 170 represents the various priority levels of the control objectives (here, 1, 2, and 3). A point 206 represents the lower bound and a point 208 represents the upper bound of the combined adjusted dispatch range for the Priority 1 control objectives for all the dispatchable elements of the microgrid 10. A point 210 represents the lower bound and a point 212 represents the upper bound of the combined adjusted dispatch range for the Priority 2 control objectives. A point 214 represents both the lower bound and the upper bound of the combined adjusted dispatch range for the Priority 3 control objectives. The dispatchable elements may be adjusted based on a ratio between priority 2 and 3 to achieve an equally beneficial dispatch for the set of control objectives across the various individual dispatchable elements of the microgrid 10. As seen in FIG. 8, the ratio may be determined as a ratio of the difference between the closest priority 3 control objective (point 214 in the plot 170 of FIG. 8) and the origin (referred to as Min3 in FIG. 8) and the difference between the priority 3 control objective and the next highest priority that is closest to the origin (here, priority 2 point 210 in plot 170 of FIG. 8) (referred to as Min2 in FIG. 8). The resulting shift function that is expected to provide the greatest benefit across the dispatchable elements equally may be written as Min3+Ratio×(Min2−Min3).

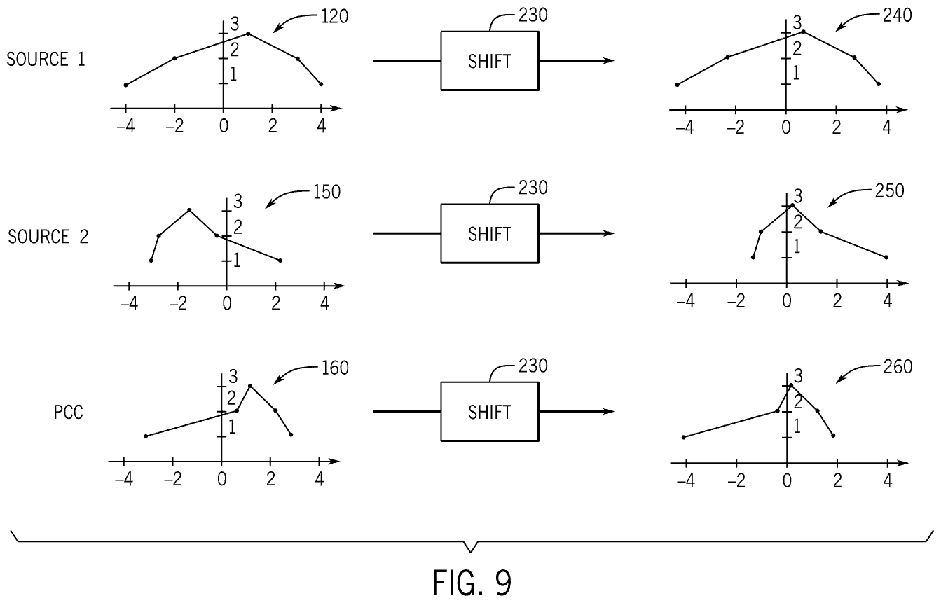

FIG. 9 illustrates the application of a shift function 230, calculated as described above, across the various dispatchable elements of the microgrid 10. A plot 240 illustrates the effect of applying the shift function 230 to the generator G1 26, a plot 250 illustrates the effect of applying the shift function 230 to the generator G2 28, and a plot 260 illustrates the effect of applying the shift function 230 to the PCC 14. The result of the shift function 230 is that the priority dispatch region of each individual source shows the vertical axis intersecting the line between priority 2 and priority 3 with the same ratio.

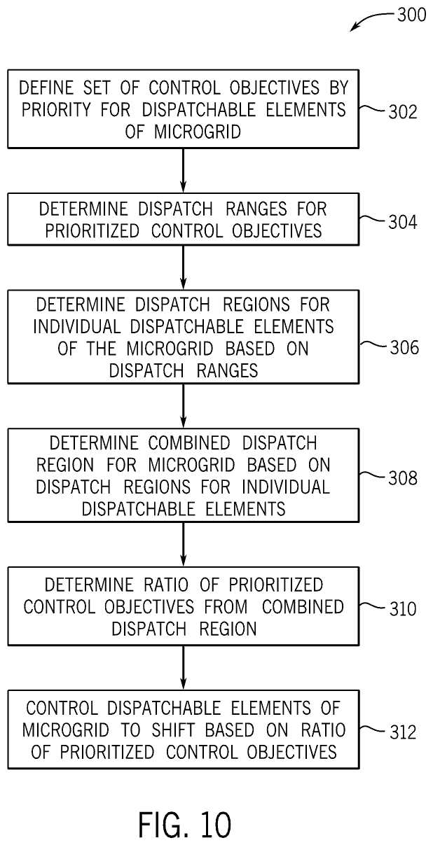

FIG. 10 is a flowchart 300 of a method for controlling the various dispatchable elements of a microgrid, such as the microgrid 10 shown in FIG. 1, according to prioritized control objectives. The flowchart 300 may be carried out by the monitoring and control system 32 and/or other data processing systems. For example, defining the set of control objectives for the dispatchable elements may take place using a different data processing system in advance. The control objectives may be defined and categorized according to priority for some or all dispatchable elements of the microgrid (block 302). Dispatch ranges may be determined based on the various control objectives (block 304), which are adjusted to obtain a dispatch region for each dispatchable element (block 306). Note that there may be any suitable number of priorities. For example, the following tables provide an example of determining and adjusting dispatch ranges for 10 different priorities.

TABLE 1
Independent Dispatch Ranges

| Priority | Minimum | Maximum |
|---|---|---|
| 1 | −100 | 100 |
| 2 | −80 | 120 |
| 3 | −65 | 100 |
| 4 | −80 | 20 |
| 5 | 10 | 100 |
| 6 | 20 | 90 |
| 7 | 30 | 40 |
| 8 | 20 | 20 |
| 9 | 10 | 10 |
| 10 | 10 | 10 |

TABLE 2
Adjusted Dispatch Ranges

| Priority | Minimum | Maximum |
|---|---|---|
| 1 | −100 | 100 |
| 2 | −80 | 100 |
| 3 | −65 | 100 |
| 4 | −65 | 20 |
| 5 | 10 | 20 |
| 6 | 20 | 20 |
| 7 | 20 | 20 |
| 8 | 20 | 20 |
| 9 | 20 | 20 |
| 10 | 20 | 20 |

As mentioned above, a plot of the adjusted dispatch range versus the priority represents a priority dispatch region. A characteristic of all priority dispatch regions is that the dispatch range narrows as the priority number increases. Priority 10 will have a range equal to or less than priority 9, priority 9 will have a range equal to or less than priority 8, and so on.

Continuing with the flowchart 300 of FIG. 10, a combined dispatch region may be obtained by combining the dispatch regions determined for the various dispatchable elements (block 308). Additionally or alternatively, adjusted dispatch ranges may be determined without first determining the individual dispatch regions of the dispatchable elements. In either case, a based on the combined dispatch region, a ratio of the prioritized control objectives from the combined dispatch region may be calculated (block 310) and a corresponding shift function may be applied to the dispatchable elements (block 312). In this way, a variety of control objectives may be met despite possible conflict. The method thus may accommodate disparate situations such as peak shaving, fuel reduction, renewable maximization/curtailment, synchronization, disconnect preparation, and transition smoothing based on the prioritized control objectives to manage these various conditions.

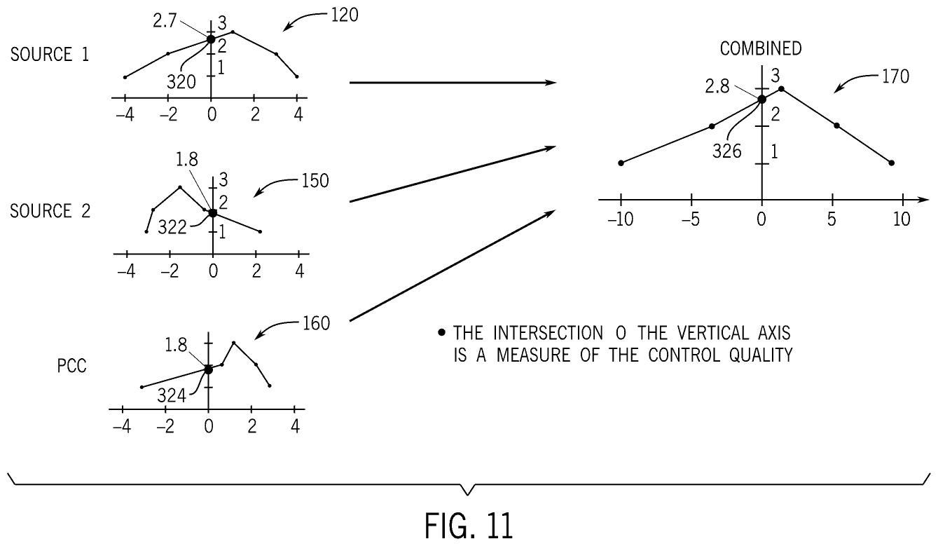

The combined prioritized dispatch region plot 170 also provides a way to visualize a quality metric of the present dispatch of the dispatchable elements of a microgrid (e.g., the microgrid 10). For example, as shown in FIG. 11, one indicator of the control quality is the y-intercept of a prioritized dispatch region plot (representing an effective priority level that is satisfied if no change is made to the dispatch). In the example of FIG. 11, prior to the dispatch (e.g., prior to shifting the dispatchable elements by the shift function 230, as illustrated in FIG. 9), the control quality may be lower for the individual dispatchable elements of the microgrid 10. In the prioritized dispatch region plot 120 for the generator G1 26, the y-intercept control quality indicator is 2.7. In the prioritized dispatch region plot 150 for the generator G2 28, the y-intercept control quality indicator is 1.8. In the prioritized dispatch region plot 160 for the PCC 14, the y-intercept control quality indicator is 1.8. Yet, as seen by the combined prioritized dispatch region plot 170, the control quality of the combined priority dispatch region represents the best that is possible; in this example, the best possible control quality is 2.8.

The control quality indicator may be provided to operators of a microgrid to clarify the way that the control scheme is currently addressing the various control objectives of the microgrid. Moreover, various plots such as those described in this disclosure may also be presented to operators to provide a straightforward understanding of the state of the control system of the microgrid.

While specific embodiments and applications of the disclosure have been illustrated and described, it is to be understood that the disclosure is not limited to the precise configurations and components disclosed herein. For example, the systems and methods described herein may be applied to an industrial electric power delivery system or an electric power delivery system implemented in a boat or oil platform that may or may not include long-distance transmission of high-voltage power. Accordingly, many changes may be made to the details of the above-described embodiments without departing from the underlying principles of this disclosure. The scope of the present disclosure should, therefore, be determined only by the following claims.

Indeed, the embodiments set forth in the present disclosure may be susceptible to various modifications and alternative forms, specific embodiments have been shown by way of example in the drawings and have been described in detail herein. However, it may be understood that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). For any claims containing elements designated in any other manner, however, it is intended that such elements are not to be interpreted under 35 U.S.C. 112(f).

What is claimed is:

1. A monitoring and control system comprising a data processing system configured to execute instructions stored on one or more tangible, non-transitory, machine-readable media to perform operations comprising:
determine a set of prioritized control objectives corresponding to a plurality of dispatchable elements of a microgrid;
determine a combined dispatch region corresponding to combined dispatch ranges of the plurality of dispatchable elements based on the set of prioritized control objectives; and
control the plurality of dispatchable elements based on the combined dispatch region.

2. The monitoring and control system of claim 1, wherein controlling the plurality of dispatchable elements based on the combined dispatch region comprises issuing dispatch commands to shift power in respective dispatchable elements of the dispatchable elements based on the combined dispatch region.

3. The monitoring and control system of claim 2, wherein the dispatch commands are to shift power in the respective dispatchable elements by different respective amounts.

4. The monitoring and control system of claim 2, wherein the dispatch commands are to shift power in the respective dispatchable elements in equal proportion to a respective subset of the set of the prioritized control objectives corresponding to the respective dispatchable elements.

5. The monitoring and control system of claim 2, wherein issuing dispatch commands to shift power in the respective dispatchable elements based on the combined dispatch region comprises:
determining a ratio of prioritized control objectives from the combined dispatch region; and
determining the dispatch commands to shift power for the respective dispatchable elements based on the ratio.

6. The monitoring and control system of claim 5, wherein the ratio of prioritized control objectives comprises a ratio of:
a difference between a lowest priority control objective dispatch power and a presently measured power of the combined dispatch region; and
a difference between the lowest priority control objective dispatch power and a next-lowest priority control objective dispatch power that is closest to the presently measured power of the combined dispatch region.

7. The monitoring and control system of claim 6, wherein the dispatch commands to shift power are determined for respective dispatchable elements based on the following shift function:
a lowest priority control objective dispatch power of a respective subset of the set of the prioritized control objectives corresponding to the respective dispatchable elements, added to
a product of:
the ratio; and
a difference between:
the lowest priority control objective dispatch power of the respective subset of the set of the prioritized control objectives corresponding to the respective dispatchable elements; and
a next-lowest priority control objective dispatch power that is closest to the presently measured power of the respective subset of the set of the prioritized control objectives corresponding to the respective dispatchable elements.

8. The monitoring and control system of claim 1, wherein determining the set of prioritized control objectives comprises determining limits of dispatchable active power or dispatchable reactive power for the respective dispatchable elements of the microgrid.

9. The monitoring and control system of claim 1, wherein the operations comprise:
determining respective dispatch ranges of the respective dispatchable elements based on the set of prioritized control objectives;
determining respective dispatch regions corresponding to the respective dispatch ranges; and
determining the combined dispatch region based on a combination of the respective dispatch regions.

10. A microgrid system comprising:
a plurality of dispatchable elements of the microgrid; and
a control system configured to dispatch the dispatchable elements based on a ratio of a first prioritized control objective in relation to a present power level and the first prioritized control objective in relation to a second prioritized control objective having a higher priority.

11. The microgrid system of claim 10, wherein the plurality of dispatchable elements of the microgrid comprises a generator.

12. The microgrid system of claim 10, wherein the plurality of dispatchable elements of the microgrid comprises a point of common coupling (PCC) to a macrogrid or another microgrid.

13. The microgrid system of claim 10, wherein the plurality of dispatchable elements of the microgrid comprises a dispatchable load.

14. The microgrid system of claim 10, wherein the plurality of dispatchable elements of the microgrid comprises a replenishable electric storage system.

15. The microgrid system of claim 10, wherein the control system is configured to dispatch the dispatchable elements based on a shift function based on the ratio.

16. A method comprising:
determining dispatch ranges corresponding to prioritized control objectives of a plurality of dispatchable elements of a microgrid; and
controlling the plurality of dispatchable elements based on the dispatch ranges corresponding to the prioritized control objectives of the plurality of dispatchable elements of the microgrid.

17. The method of claim 16, comprising:
determining individual dispatch regions for each of the plurality of dispatchable elements; and
determining a combined dispatch region for the microgrid based on the individual dispatch regions for each of the plurality of dispatchable elements;
wherein the plurality of dispatchable elements are controlled based on the combined dispatch region.

18. The method of claim 16, wherein controlling the plurality of dispatchable elements comprises issuing dispatch commands to shift power in respective dispatchable elements in equal proportion to respective prioritized control objectives of the respective dispatchable elements.

19. The method of claim 16, wherein the dispatch ranges comprise ranges of limits of dispatchable active power or dispatchable reactive power for the respective dispatchable elements of the microgrid.

20. The method of claim 16, wherein controlling the plurality of dispatchable elements comprises issuing dispatch commands to shift power in the respective dispatchable elements, wherein the method comprises:
determining a ratio of prioritized control objectives based on the dispatch ranges; and
determining the dispatch commands to shift power for the respective dispatchable elements based on the ratio.
